(19) United States
(12) Patent Application Publication
(10) Pub. No.: US 2010/0003032 A1
(43) Pub. Date: Jan. 7, 2010

(54) Integration of WDM channels with disparate bit rates

(75) Inventors: Alain Houle, Petaluma, CA (US); Bengt Johansson, Hagersten (SE); Jeff Hamilton-Gahart, Santa Rosa, CA (US)

Correspondence Address: EDELL, SHAPIRO & FINNAN, LLC, 1901 RESEARCH BOULEVARD, SUITE 400, ROCKVILLE, MD, 20850, US

(73) Assignee: Cisco Technology, Inc., San Jose, CA (US)

(21) Appl. No.: 10/072,707

(22) Filed: Feb. 5, 2002

(51) Int. Cl. H04J 14/02

(52) U.S. Cl. 398/79

(57) ABSTRACT

Systems and methods for upgrading selected wavelengths in a WDM link to higher data rates at minimal expense are provided. Error correction coding techniques are employed such that the data encoded onto the upgraded wavelengths experiences higher coding gain than that experienced by data encoded on the non-upgraded wavelengths. This increases receiver sensitivity without the use of expensive opto-electronic components. In one embodiment, Reed-Solomon coding is employed on the upgraded wavelengths and no error correction coding is employed on the remaining wavelengths. These techniques may also be applied to new WDM links carrying channels with disparate bit rates.

### BACKGROUND OF THE INVENTION

The present invention relates to optical communication systems and more particularly to links employing wavelength division multiplexing (WDM).

The enormous growth in telecommunication traffic is driving the development of technology to greatly expand the available bandwidth of service provider and enterprise networks. In particular, there is a great impetus towards increasing the capacity of optical communication links and reducing the costs of implementing capacity-increasing technologies. Many optical communication links employ wavelength division multiplexing (WDM) technology where multiple optical signals are combined onto the same fiber to increase capacity. It is desirable to increase the capacity of such WDM links by increasing the data rate on individual wavelengths on the link.

One possible approach is to simply increase the data rate on all of the wavelengths on the link. Due to the need to replace all of the individual transmitters and receivers provided for each wavelength with higher data rate counterparts and also modify and/or replace amplification components, this will be very expensive. Yet it may be the case that not all of this new capacity is required immediately such that the return on this large investment may be far in the future. The desire then arises to increase the data rate carried on some wavelengths but not on others.

A consideration of the design characteristics of a WDM link leads to a realization that implementing a mixed data rate WDM system is not at all straightforward. All of the WDM wavelengths are amplified together at many points along the link, exploiting the broad bandwidth of modern optical amplification technologies such as Raman amplification and/or Erbium-doped fiber amplification to save on amplifier costs. To satisfy the dynamic range requirements of the amplifiers, the system operates so that each wavelength has the same power level.

This constant power level across wavelength raises a problem in a mixed data rate system in that receiver sensitivity will be less for the high data rate wavelengths due to their broader signal bandwidths and consequently higher noise levels and lower signal to noise ratios. The power levels at the link's receiver end, although adequate for correct operation of the lower data rate wavelength receivers, will be inadequate to assure correct operation of the higher data rate receivers. One solution is to completely reconfigure the link to increase the power level at each wavelength so that the higher data rate receivers will operate at a sufficiently high signal to noise ratio. This is very expensive and will moreover cause an interruption of traffic on the existing channels.

What is needed is an approach to upgrading selected wavelengths of a WDM system to higher data rates that minimizes cost and the need to modify and/or replace components along the link.

### SUMMARY OF THE INVENTION

Systems and methods for upgrading selected wavelengths in a WDM link to higher data rates at minimal expense are provided by virtue of one embodiment of the present invention. Error correction coding techniques are employed such that the data encoded onto the upgraded wavelengths experiences higher coding gain than that experienced by data encoded on the non-upgraded wavelengths. This increases receiver sensitivity without the use of expensive opto-electronic components. In one embodiment, Reed-Solomon coding is employed on the upgraded wavelengths and no error correction coding is employed on the remaining wavelengths. These techniques may also be applied to new WDM links carrying channels with disparate bit rates.

A first aspect of the present invention provides a method for transmitting a WDM signal. The method includes: modulating a first optical signal on a first wavelength with a first data signal having a first data rate to generate a first modulated optical signal having a first bandwidth, modulating a second optical signal on a second wavelength with a second data signal having a second data rate to generate a second modulated optical signal having a second bandwidth, the second bandwidth being greater than the first bandwidth and the WDM signal comprising the first modulated optical signal and the second modulated optical signal, and applying error correction coding to the second data signal so that the second data signal experiences a greater coding gain than the first data signal.

A second aspect of the present invention provides a method of receiving a WDM signal. The method includes demodulating a first modulated optical signal derived from the WDM signal to form a first recovered data signal, the first modulated optical signal having a first bandwidth, demodulating a second modulated optical signal derived from the WDM signal to form a second recovered data signal, the second modulated optical signal having a second bandwidth greater than the first bandwidth, and decoding the second recovered data signal in accordance with an error correction coding scheme wherein the error correction coding scheme of the second recovered data signal compensates for a lower signal to noise ratio of the second modulated optical signal relative to the first modulated optical signal.

Further understanding of the nature and advantages of the inventions herein may be realized by reference to the remaining portions of the specification and the attached drawings.

### BRIEF DESCRIPTION OF THE DRAWINGS

FIG. 1 depicts a WDM link suitable for implementing one embodiment of the present invention.

FIG. 2 depicts a WDM transmitter system according to one embodiment of the present invention.

FIG. 3 depicts a WDM receiver system according to one embodiment of the present invention.

### DESCRIPTION OF SPECIFIC EMBODIMENTS

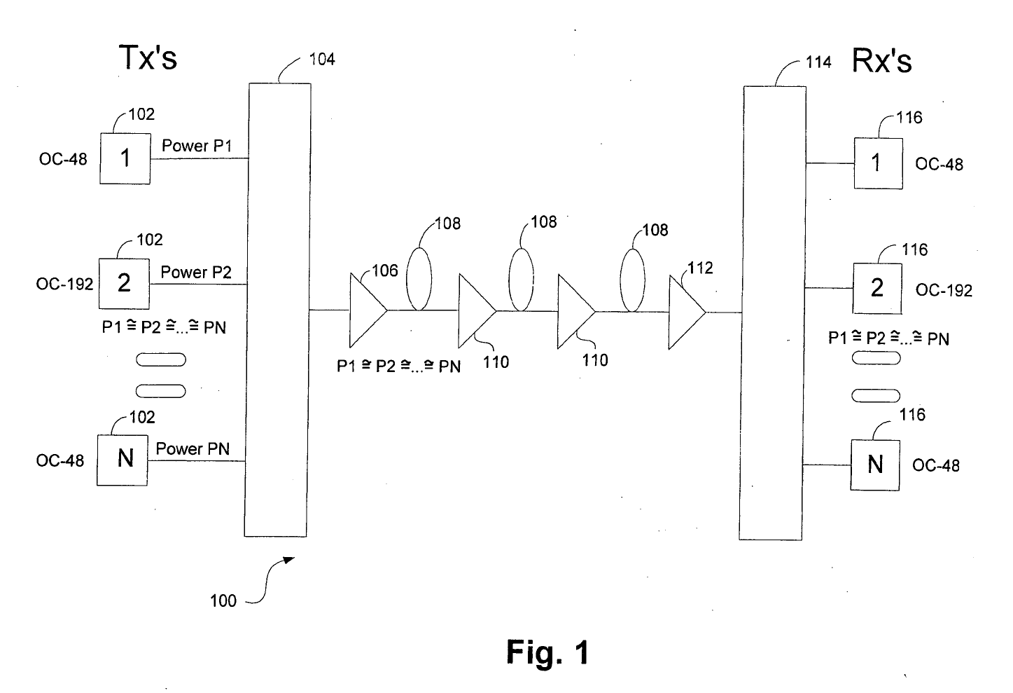

The present invention finds application in optical communication systems, for example, in WDM communication links. FIG. 1 depicts a representative WDM communication link 100. Link 100 may be used for, e.g., long haul (LH), ultra long haul (ULH), “metro” networks, “last mile” access, etc. Link 100 may form part of a ring. There are N WDM wavelengths or channels, each modulated with a different data stream. In link 100, channel 1 and channel N are depicted as carrying an OC-48 signal that has a data rate of 2.5 Gbps. Channel 2 is depicted as carrying an OC-192 signal having a data rate of 10 Gbps. The remaining channels (not shown) are mixed between OC-48 and OC-192. In one representative application, link 100 was initially established to carry multiple OC-48 signals but has now been partially upgraded according to one embodiment of the present invention so that certain wavelengths carry OC-192 but other wavelengths continue to carry OC-48.

At the transmit end of the link, a series of transmitters 102 are provided, one transmitter for each wavelength. Each transmitter receives a data stream and uses the data stream to modulate an optical signal at the selected wavelength. A multiplexer 104 combines the various wavelengths onto a single transmission fiber. An amplifier 106 brings the signal to a desired transmission power level. A separate attenuator for each channel (not shown) may also be provided prior to multiplexer 104 to equalize the transmission powers of the multiple channels.

Link 100 may extend over a distance such that it is necessary to provide intermediate optical amplification to preserve the composite WDM signal. Accordingly, link 100 is divided into 3 fiber spans 108 with amplifiers 110 located between the spans. Of course, it will be appreciated that the number of spans depicted is merely representative and that in certain applications, intermediate amplification will not be necessary. Amplifiers 110 may be, e.g., Erbium-doped fiber amplifiers (EDFAs), discrete Raman amplifiers (DRAs), etc. Distributed Raman amplification may also be employed by appropriately injection of optical pump energy into fiber spans 108. Amplifiers 110 may be understood to also denote more complex amplification systems that, e.g., break up the WDM signal into subbands or even individual wavelength components, incorporate multiple amplification technologies, or also compensate for chromatic dispersion effects within spans 108.

At the receiver end, an amplifier 112 amplifies the received signal. A demultiplexer 114 separates the composite WDM signal into individual wavelength components. There may, alternatively, be a more complex demultiplexing architecture with a multiple stage demultiplexer and per-subband pre-amplification. Amplifier 112 may incorporate any suitable amplification technology. There may also be further amplification for each channel. A separate receiver 116 is provided for each wavelength to recover the transmitted OC-48 or OC-192 data signal. It will of course be appreciated that OC-48 and OC-192 are merely representative data rates that may be carried across a WDM link such as link 100 in accordance with the present invention and that in fact any mixed data rate scheme may be accommodated.

It will be appreciated that many aspects of the design of link 100 may have been determined with reference to the requirements of transmitting optical signals that have been modulated with OC-48 data signals. In particular, transmission powers and gain levels have been chosen so as to assure that OC-48 receivers are presented with optical signals having sufficient signal to noise ratio while assuring that signal levels are not so high as to exceed the dynamic range limitations of either the receivers or any of the amplifiers employed by link 100. Each wavelength employs the same transmission power and experiences substantially similar gains and attenuations along the link. The OC-192 receivers, however, require a higher optical signal to noise ratio than the OC-48 receivers due to the higher noise power associated with the larger detection bandwidth required for detecting OC-192 signals. For example, typical OC-48 receivers may recover data accurately with an optical signal to noise ratio as low as 18 dB while the OC-192 receiver will require an optical signal to noise ratio of 24 dB.

According to one embodiment of the present invention, a lower OSNR requirement and/or a lower receiver sensitivity requirement is provided to the higher data rate signals by employing error correction coding techniques. In one implementation, the higher data rate signals employ error correction coding on the modulated data while the lower data rate signals do not. The lower data rate signals may then be understood to have a coding gain of zero. Alternatively, error correction coding techniques may also be employed on both the higher data rate and lower data rate signals with different coding gains. In an alternate embodiment, there are 3 or more tiers of data rate, with different coding gains assigned to the data rates.

In the exemplary implementation that will be discussed in detail herein, error correction coding is employed in conjunction with the OC-192 signals but not with the OC-48 signals. In particular, forward error correction (FEC) techniques are employed. A Reed-Solomon code as specified by the well-known ITU G.975 standard is applied to the OC-192 data at the transmit end. A Reed-Solomon decoder at the receiver end recovers the transmitted data.

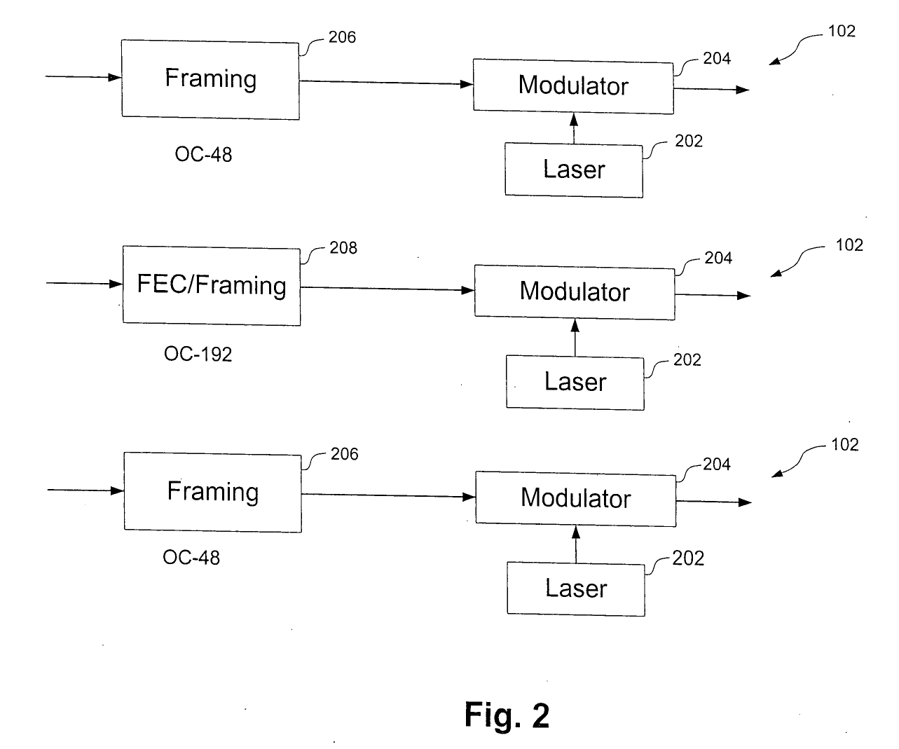

FIG. 2 depicts details of 3 of transmitters 102 according to one embodiment of the present invention. Each transmitter 102 incorporates a laser 202 to generate coherent optical energy at an assigned wavelength. The laser output is modulated with a data signal by a modulator 204. Alternatively, the laser may be amplitude modulated by controlling an input. In any case, the modulation input is an analog signal encoded with the digital data to be transmitted. Digital to analog conversion equipment is omitted for simplicity of depiction.

For the OC-48 signals, digital data is formatted prior to modulated by a framer 206. Framer 206 forms the data into frames.

By contrast, for the OC-192 signals, a forward error correction/framing block 208 is employed. In one embodiment, block 208 applies a Reed-Solomon code specified by the G.975 standard. The Reed-Solomon code is a (255,239) linear cyclic systematic block code. Alternatively, the error correction coding is in accordance with the well-known G.709 standard. Other enhanced forward error correction codes may be used including codes providing greater coding gain than that provided by the G.975 and G.709 standards, e.g., 3 dB or more of coding gain improvement. As with all error correction codes, redundancy is added to the transmitted information to assist the receiver in accurately recovering the information in the presence of corrupting noise. In this specific implementation, the coding gain is 6 dB, i.e., the use of the error correction code lowers the minimum required signal to noise ratio by 6 dB.

The modulated optical signals are combined by multiplexer 104 for transmission down the link and amplified by amplifier 106 to a desired transmission power level. Pre-multiplexer attenuators may adjust the power levels of individual channels. Inter-span amplifiers 110 need not be modified due to the upgrading of certain wavelengths to OC-192 service.

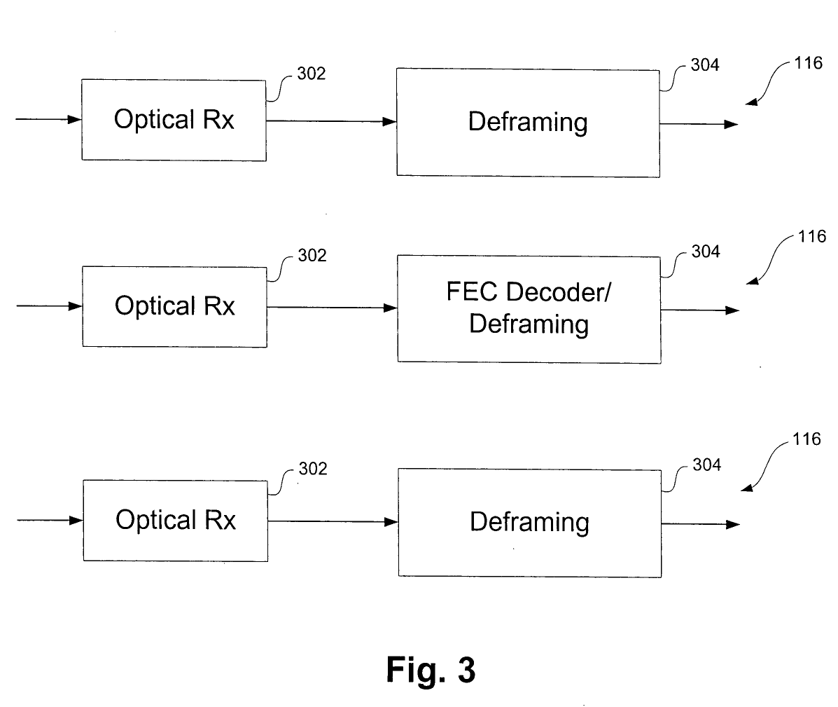

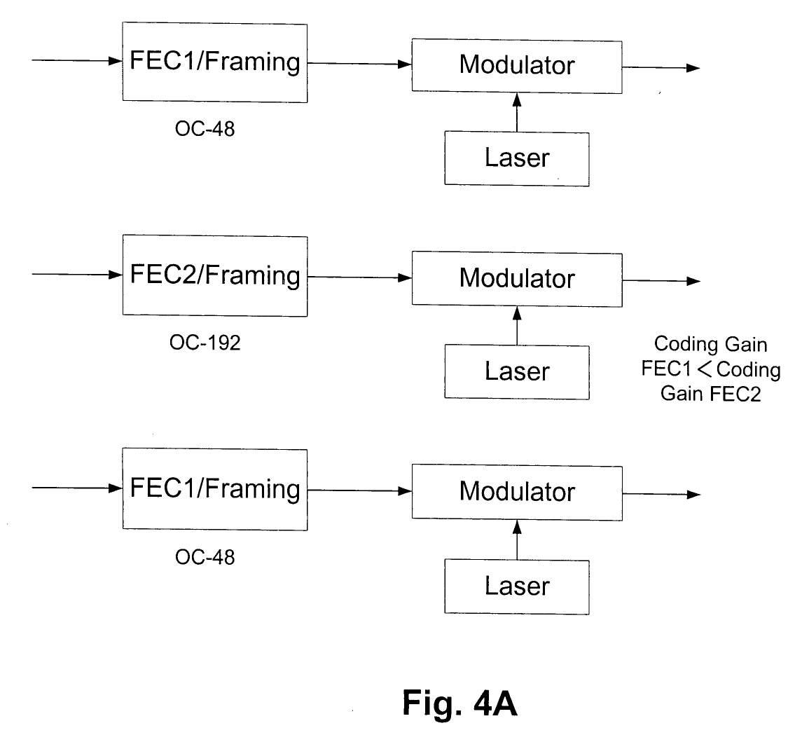

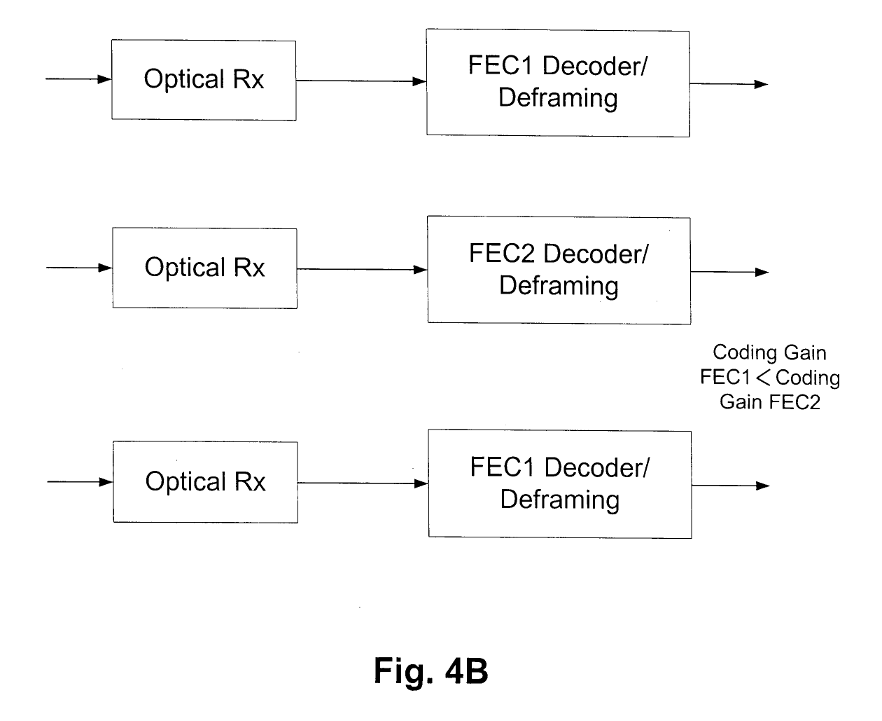

FIG. 3 depicts details of receivers 116 according to one embodiment of the present invention. The receiver details vary depending on whether the assigned wavelength is configured for OC-192 transmission or OC-48 transmission. The modulated optical signals are fed to optical receiver blocks 302. Optical receiver blocks 302 incorporate photodiodes that recover an analog electrical signal representing the modulation envelope of the received optical signal. Optical receiver blocks 302 also incorporate analog to digital conversion circuitry to recover modulation data. Various signal conditioning components and the exact structure of the conversion circuitry may vary between the OC-192 receivers and the OC-48 receivers.

For the OC-48 receivers, the modulation data is sent to deframing blocks 304. Deframing blocks 304 extract data from the frames. For the OC-192 receivers, a deframing/decoder block 306 retrieves the encoded data from the frames and then decodes the data in accordance with the G.975 standard (or whatever alternative standard such as G.709 as been used to encode the data) to recover the transmitted data.

In certain applications, chromatic dispersion compensation should be added to decrease the total dispersion to meet the transmitter-receiver specified value. This can be done on a per-channel basis or for the whole band.

Even though the OC-192 receivers are less sensitive than the OC-48 receivers, the coding gain provided by use of the Reed-Solomon code assures accurate recovery of the transmitted data. There is no requirement to modify and/or replace the receiver and transmitter equipment used for the OC-48 wavelengths, greatly reducing the cost of upgrading the link to accommodate OC-192 data transmission on selected wavelengths. It is also not necessary to modify the amplifiers used along the link. It should be noted that forward error correction is used here to effectively equalize the reaches of the disparate data rate optical signals rather than to simply extend any of them.

It is understood that the examples and embodiments that are described herein are for illustrative purposes only and that various modifications and changes in light thereof will be suggested to persons skilled in the art and are to be included within the spirit and purview of this application and scope of the appended claims and their full scope of equivalents.

1. A method for transmitting a WDM signal:
modulating a first optical signal on a first wavelength with a first data signal having a first data rate to generate a first modulated optical signal having a first bandwidth;
modulating a second optical signal on a second wavelength with a second data signal having a second data rate to generate a second modulated optical signal having a second bandwidth, said second bandwidth being greater than said first bandwidth and said WDM signal comprising said first modulated optical signal and said second modulated optical signal; and
applying error correction coding to said first and second data signals such that said second data signal experiences a greater coding gain than said first data signal.

2. (canceled)

3. (canceled)

4. (canceled)

5. The method of claim 1 wherein said first data signal comprises an OC-48 signal and said second data signal comprises an OC-192 signal.

6. The method of claim 1 further comprising:
multiplexing said first modulated optical signal and said second modulated optical signal together to form said WDM signal.

7. The method of claim 1 wherein said first modulated optical signal and said second modulated optical signal have substantially similar power levels when multiplexed together.

8. (canceled)

9. A method of receiving a WDM signal, said method comprising:
demodulating a first modulated optical signal derived from said WDM signal to form a first recovered data signal, said first modulated optical signal having a first bandwidth;
demodulating a second modulated optical signal derived from said WDM signal to form a second recovered data signal, said second modulated optical signal having a second bandwidth greater than said first bandwidth; and
decoding said first and second recovered data signals in accordance with error correction coding applied to first and second data signals wherein a lower signal to noise ratio of said second modulated optical signal is compensated for relative to said first modulated optical signal.

10. (canceled)

11. (canceled)

12. (canceled)

13. The method of claim 9 wherein said first recovered data signal comprises an OC-48 signal and said second recovered data signal comprises an OC-192 signal.

14. The method of claim 9 wherein said first modulated optical signal and said second modulated optical signal are received with substantially similar power levels.

15. (canceled)

16. A WDM transmission system comprising:
a first transmitter generating a first modulated optical signal that has been modulated with a first data signal;
a second transmitter generating a second modulated optical signal that has been modulated with a second data signal;
a first error correction coding block that applies an error correcting code to said first data signal prior to modulation; and
a second error correction coding block that applies an error correcting code to said second data signal prior to modulation so that a coding gain of said second modulated optical signal is greater than any coding gain of said first modulated optical signal.

17. (canceled)

18. (canceled)

19. (canceled)

20. The WDM transmission system of claim 16 wherein a bandwidth of said second modulated optical signal is greater than a bandwidth of said first modulated optical signal.

21. The WDM transmission system of claim 16 further comprising:
a first amplifier that amplifies said first modulated optical signal; and
a second amplifier that amplifies said second modulated optical signal, wherein amplified power levels of said first modulated optical signal and said second modulated optical signals are substantially similar.

22. The WDM transmission system of claim 21 further comprising:
a multiplexer that combines said first modulated optical signal and said second modulated optical signal to form a WDM signal.

23. The WDM transmission system of claim 21 wherein said first data signal comprises an OC-48 signal and said second data signal comprises an OC-192 signal.

24. A WDM receiver system comprising:
a first optical receiver that recovers a first recovered data signal from a first modulated optical signal on a first wavelength;
a second optical receiver that recovers a second recovered data signal from a second modulated optical signal on a second wavelength;
a first error correction decoding block that decodes said first recovered data signal in accordance with an error correcting code imposed on data of said first recovered data signal; and
a second error correction decoding block that decodes said second recovered data signal in accordance with an error correcting code imposed on data of said second recovered data signal, said error correcting code of said second error correction decoding block compensating for a lower signal to noise ratio of said second modulated optical signal compared to said first modulated optical signal.

25. The WDM receiver system of claim 24 wherein said first recovered data signal comprises an OC-48 signal and said second recovered data signal comprises an OC-192 signal.

26. (canceled)

27. The WDM receiver system of claim 24 wherein said second modulated optical signal has a greater bandwidth than said first modulated optical signal.

28. (canceled)

29. (canceled)

30. (canceled)

31. The WDM receiver system of claim 24 wherein said first modulated optical signal and said second modulated optical signals are received with substantially similar power levels.

32. Apparatus for transmitting a WDM signal:
means for modulating a first optical signal on a first wavelength with a first data signal having a first data rate to generate a first modulated optical signal having a first bandwidth;
means for modulating a second optical signal on a second wavelength with a second data signal having a second data rate to generate a second modulated optical signal having a second bandwidth, said second bandwidth being greater than said first bandwidth and said WDM signal comprising said first modulated optical signal and said second modulated optical signal;
means for applying error correction coding to said first data signal; and
means for applying error correction coding to said second data signal so that said second data signal experiences a greater coding gain than said first data signal.

33. An apparatus for receiving a WDM signal comprising:
means for demodulating a first modulated optical signal derived from said WDM signal to form a first recovered data signal, said first modulated optical signal having a first bandwidth;
means for demodulating a second modulated optical signal derived from said WDM signal to form a second recovered data signal, said second modulated optical signal having a second bandwidth greater than said first bandwidth;
means for decoding said first recovered data signal; and
means for decoding said second recovered data signal in accordance with an error correction coding scheme wherein said error correction coding scheme of said second recovered data signal compensates for a lower signal to noise ratio of said second modulated optical signal relative to said first modulated optical signal.
